(19) United States
(12) Patent Application Publication
(10) Pub. No.: US 2009/0294139 A1
(43) Pub. Date: Dec. 3, 2009

(54) Vehicle for Fire Control and Fire Rescue Operations in Extreme Wildlands

(76) Inventor: Robert H. WILSON, Austin, TX (US)

Correspondence Address: KAMMER BROWNING PLLC, 7700 BROADWAY, SUITE 202, SAN ANTONIO, TX, 78209, US

(21) Appl. No.: 12/473,045

(22) Filed: May 27, 2009

Related U.S. Application Data
(60) Provisional application No. 61/056,337, filed on May 27, 2008.

(51) Int. Cl. A62C 27/00

(52) U.S. Cl. 169/24

(57) ABSTRACT

A mid-sized firefighting and fire rescue vehicle capable of accessing a range of off-road wildland environments that is also “street legal” for rapid on-road transportation. The vehicle is configured to be outfitted as needed with any of a variety of different firefighting or fire rescue systems packaged as removable modules, fixed in place in the bed of the vehicle. The vehicle achieves stability and ruggedness through the use of three military type axles, two of which (the rear axles) are both drive axles. The vehicle is further configured with an open bed structured to receive, position, and retain an integrated, modularly structured, firefighting or fire rescue system in such a manner as may be switched out with alternate systems as required for the type of service into which the vehicle is called. The vehicle has a narrow gauge (width) that allows it to access remote and obstructed areas but is still large enough to adequately carry personnel and equipment safely to and from most wildland fire environments. The bed of the vehicle utilizes a quick load and unload system that includes either rails or alignment guide posts in a manner that allows the user to quickly change the vehicle's primary function.

### CROSS REFERENCE TO RELATED APPLICATIONS

This application claims the benefit under Title 35 United States Code §119(e) of U.S. Provisional Patent Application Ser. No.: 61/056,337; filed May 27, 2008; the full disclosure of which is incorporated herein by reference.

### BACKGROUND OF THE INVENTION

1. Field of the Invention

The present invention relates generally to vehicles utilized in conjunction with firefighting and fire rescue operations. The present invention relates more specifically to modular vehicular systems that can access extreme wildland environments and transport a variety of modularized firefighting and fire rescue equipment while still offering a street legal configuration.

2. Description of the Related Art

There are many different types of motorized vehicles currently in use in the field of firefighting and fire rescue. Very large and complex machinery has been developed over time to provide firefighters with the tools required to control and extinguish fires as well as assist in the rescue of individuals caught within the fires. Most of the vehicles and machinery developed are suitable for use primarily in urban environments or in unobstructed open areas. A problem frequently faced by firefighting agencies is accessibility to confined, hilly, forested, off-road areas. Very few of the vehicles developed for use in urban areas lend themselves to use within such so-called “wildland” environments.

While many fire departments and firefighting agencies utilized standard off-road Jeep® type vehicles, these vehicles are capable of little more than transporting individuals closer to the wildland areas and seldom are able to venture into and through these areas to the location of the fire. These off-road vehicles are typically too wide to allow easy access to remote wildland areas, especially heavily forested areas. There are smaller vehicles that firefighting agencies do employ against fires in backwoods or wildland areas, but these vehicles must typically be brought in as close as possible on flatbed trailers and the like where they are unloaded and pressed into service. In other words, these smaller vehicles are generally not configured to be “street legal” and are not designed for rapid transport over paved roads.

In addition to the accessibility problem described above, fire fighting agencies with fixed budgets find it difficult to obtain an maintain the variety of different types of equipment that is often required to fully respond to a variety of different types of fires. It is difficult enough to maintain a range of equipment configurations applicable to urban environments, much less duplicate all of the different types of equipment for wildlands environments. The cost ends up being prohibitive. In summary therefore, the main problem associated with fighting wildland fires is getting the right type of equipment to the right location without the need for maintaining a fleet of intermittently used vehicles.

It would be desirable, therefore, to provide a mid-sized firefighting and fire rescue vehicle capable of accessing a range of off-road wildland environments (sandy or soft ground surfaces, hilly terrain, wooded areas, boulder strewn areas, etc.) that was also configured for on-road operation (“street legal”) and which could be outfitted as needed with any of a variety of different firefighting or fire rescue systems. It would be desirable if such a vehicle was stable and rugged in off-road terrain and at the same time could rapidly travel over long highway distances to and from the scene of the fire. It would be desirable if such a vehicle could change out the type of firefighting or fire rescue equipment it carried as needed for the type of fire or type of service it was called to provide. It would be beneficial if the manufacture of such a vehicle could derive from and depend upon a certain level of existing off-road drive train technologies, especially those configured for narrow track vehicles historically utilized in the U.S. Military. It would be beneficial if these proven vehicle technologies could be integrated into a modern off-road vehicle systems and more modern firefighting systems. Currently there are no firefighting or fire rescue vehicles that provide both the accessibility and the versatility needed for the modern day firefighting agency to fully address the extreme wildlands fire.

### SUMMARY OF THE INVENTION

The present invention therefore provides a mid-sized firefighting and fire rescue vehicle capable of accessing a range of off-road wildland environments and is also “street legal” for rapid on-road operation. The vehicle is configured to be outfitted as needed with any of a variety of different firefighting or fire rescue systems packaged as removable modules, fixed in place in the bed of the vehicle. The vehicle of the present invention provides stability and ruggedness in off-road terrain and at the same time is capable of rapidly travelling over long highway distances to and from the scene of the fire. The vehicle achieves this stability and ruggedness through the use of three military type axles, two of which (the rear axles) are both drive shaft linked axles. The use of three axles (six wheels) provides better weight distribution in areas with sandy soil or soft ground. The vehicle is further configured with an open bed structured to receive, position, and retain an integrated, modularly structured, firefighting or fire rescue system in such a manner as the modular system may be switched out with alternate systems as required for the type of fire or type of environment into which the vehicle is called to service. The vehicle has a narrow gauge (width) that allows it to access remote and obstructed areas but is still large enough to adequately carry personnel and equipment safely to and from most wildland fire environments in any of the variety of efficiently structured removable modules.

The bed of the vehicle utilizes a quick load and unload system comprising either rails or alignment guide posts in a manner that allows the user to change the vehicle's primary function very quickly. This makes the vehicle versatile and highly cost effective for a variety of uses. Different modules can be slid on and off (or lifted on and off) the vehicle quickly and can be rigidly attached (latched down) during transport and actual use. Included as typical examples of the removable modules utilized are (without limitation): (a) a pumper module with foam delivery system (a CAFS—Compressed Air Foam System); (b) a pumper module with water tank; (c) an ambulance module with personnel transport; (d) a cargo module for carrying rescue and firefighting equipment; (e) a work crew module for transporting fire fighters into remote areas; (f) an extraction module with cherry picker and winching capability; (g) a ladder module with extendable ladder for multistory or elevated rescues; (h) a pump module with ground controlled articulating water or CAFS enabled boom; and (i) trailer modules that could be configured as any of the above modules that could operate as standalone systems or which could operate in conjunction with modules position on the vehicle.

In summary, therefore, the present invention has as its primary objective, solving the problem of getting the right firefighting and fire rescue equipment to the right location within a wildlands environment, without the need for maintaining an extensive fleet of different trailer transported vehicles. A further objective is to provide an off-road vehicle in a street legal configuration that is structured to receive and retain a variety of modularly configured firefighting and fire rescue systems. Further objectives and advantages will be apparent to those skilled in the art from the following description with reference to the appended drawings.

### BRIEF DESCRIPTION OF THE DRAWINGS

FIG. 1 is a side view of the motor vehicle of the present invention incorporating a typical removable module of the present invention.

FIG. 2 is a top plan view of the motor vehicle of the present invention showing the drive train components of the vehicle.

FIG. 3 is a detailed top plan view of the vehicle bed of the present invention showing a first manner of receiving and retaining the removable modules.

FIG. 4 is a detailed rear plan view of the vehicle bed of the present invention showing a second manner of receiving and retaining the removable modules.

FIG. 5 is a detailed top plan view of a compressed air foam system module of the present invention.

FIG. 6 is a detailed top plan view of a high flow water pumper module of the present invention.

FIG. 7 is a detailed top plan view of an ambulance module of the present invention.

FIG. 8 is a detailed top plan view of a work crew transport module of the present invention.

FIG. 9 is a side view of the vehicle of the present invention incorporating an example of a power boom module (extendable bucket) of the present invention.

FIG. 10 is side view of a trailer component of the present invention configured to receive and retain a module of the present invention.

### DETAILED DESCRIPTION OF THE PREFERRED EMBODIMENTS

The vehicle of the present invention, as indicated above, is designed to be a street legal vehicle that meets all the necessary vehicular standards for on-road transportation. However, an objective of the present invention is to provide a vehicle that is smaller than the standard fire rescue vehicle and which incorporates a number of features and components that enable it to facilitate firefighting and fire rescue operations in off-road (wildland) conditions and in tighter confinement. The basic structure of the vehicle, as described in more detail herein below, derives heavily from the geometry and structure of the older M151 military Jeep® type vehicle. The vehicle of the present invention will, in the preferred embodiment, incorporate three axles; one front and two rears, and will utilize military type axles like those utilized in the M151 vehicles. These military style axles allow for the two rear axles to be tied together with a short drive shaft allowing both rear axles to be under power from the engine thereby enabling much greater traction and mobility. The M151 military jeep and the M151 style axles are narrower than standard axles used in most current fire rescue vehicles. These enable the body of the vehicle to be narrower and therefore allow access confined areas (such as in off-road conditions) and yet still be configured for full vehicle functionality and street legal operation.

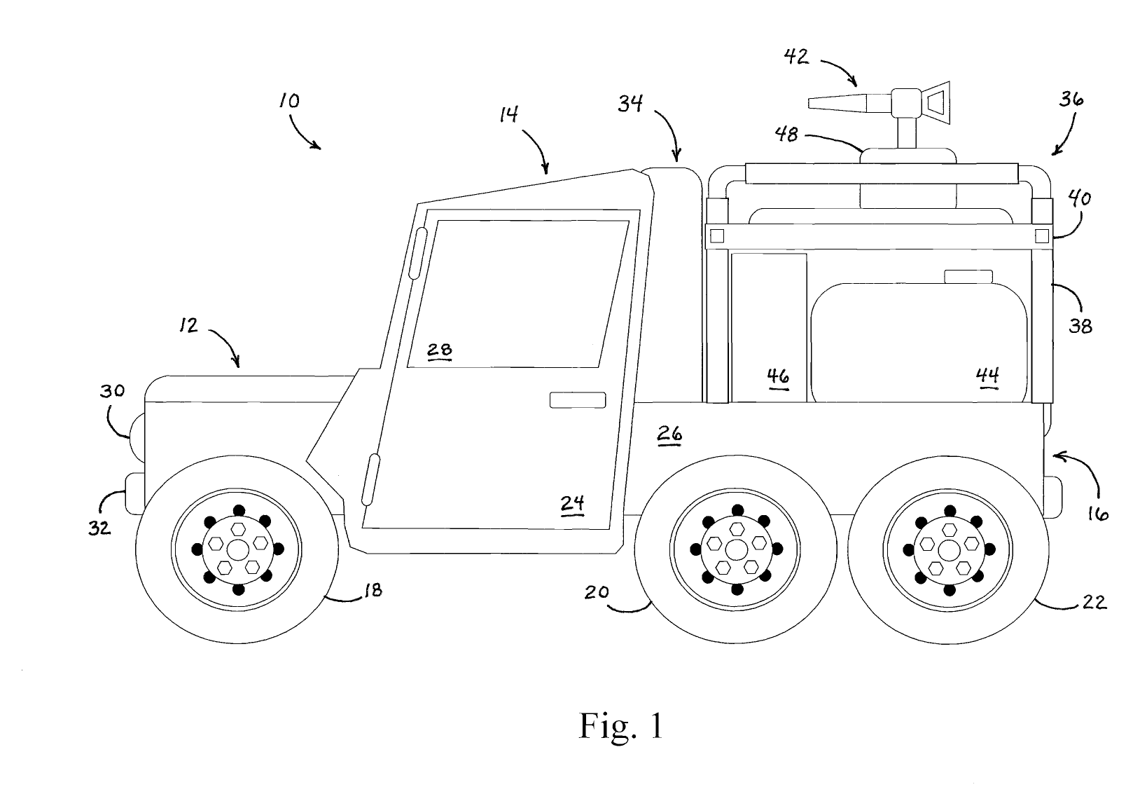

The preferred embodiments described herein and in the attached drawing figures are presented to show the basic concept of integrating removable system modules onto the bed of a mid-sized off-road/on-road vehicle. FIG. 1 is a side view of a motor vehicle of the present invention structured as described above, and incorporating a typical removable module of the present invention. Vehicle 10 shown in FIG. 1 is generally composed of engine compartment 12, vehicle cab 14, and vehicle bed 16. The three axles mentioned above are shown in profile along the left hand side of the vehicle in the view in FIG. 1 as front left wheel 18, mid left wheel 20, and rear left wheel 22. The drive train connecting these wheels and their axles with the engine of the vehicle is described in more detail below.

Vehicle cab 14 in the preferred embodiment is a two person cab having a driver's seat and a single passenger seat. Cab 14 may be fully enclosed as shown including cab door 24 and cab window 28. Alternately, cab door 24 may removed for open air operation, although many environments where the vehicle of the present invention may operate would benefit from a fully enclosed cab. Vehicle bed 16 is a generally open with bed side walls 26 and an optional or removable tailgate (not shown). It is into vehicle bed 16 that the removable modules of the present invention are positioned, retained, transported, and used.

As indicated above, it is one aspect of the present invention that vehicle 10 be street legal, thereby incorporating all of the necessary lighting and safety elements that are required of any street legal motor vehicle in the United States. Examples of these include headlights 30 and bumper 32 as shown in FIG. 1. Other features such as turn signals and safety restraints would likewise be included. In addition to the vehicle equipment necessary for the vehicle to be street legal, the preferred embodiment of the present invention would also include emergency vehicle equipment in the nature of standard emergency lighting, audible sirens, and emergency RF communications systems. All of these features are readily adaptable for the mid-size configuration of the vehicle.

Schematically disclosed in FIG. 1 is module interface 34 which is shown generally positioned external to and behind vehicle cab 14. The size and shape of modular interface 34 may vary significantly depending on the particular application of the vehicle and the manner in which the removable modules are to be connected. In general, however, module interface 34 comprises one or more panels offering a plurality of different types of electrical and conduit connectors for joining power and control systems of vehicle 10 with the necessary power and control systems of the removable modules. Preferred embodiments of module interface 34 are described in more detail below.

Shown position on vehicle 10 in FIG. 1 is a generic example of a removable module, primarily comprising module frame 36. This box-like frame structure is intended to frame and surround the components necessary for the operation of the particular modular firefighting or fire rescue system being utilized. In this example shown in FIG. 1, a liquid sprayer is generically configured within module frame 36. Frame 36 is generally supported by means of four upright frame supports 38 positioned as each corner of the module. Frame platform 40 provides an upper surface onto which nozzle rotation platform 48 and pressure nozzle 42 are positioned and operate. Within the confines of module frame 36 are generically positioned liquid tank 44 and liquid pump system 46. As indicated above, the removable module shown in FIG. 1 is intended to be generic for the purposes of showing the manner in which the module (and any of the modules described herein) may be positioned on and connected to motor vehicle 10.

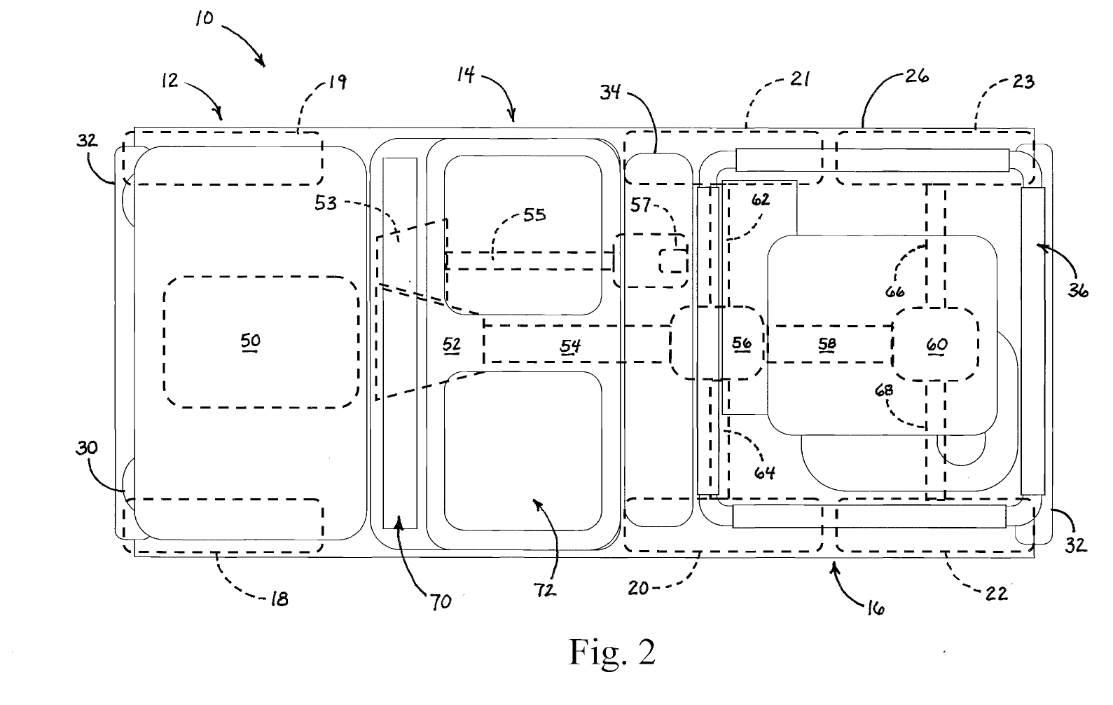

Reference is now made to FIG. 2 for a top plan view of the motor vehicle of the present invention primarily disclosing the drive train components of the vehicle. Vehicle 10 shown in FIG. 2 is once again comprised generally of three discrete sections including; vehicle engine compartment 12, vehicle cab 14, and vehicle bed 16. In this top plan view, each of the six wheels of the vehicle are shown in dashed outline form. These include; front left wheel 18, front right wheel 19, mid left wheel 20, mid right wheel 21, rear left wheel 22, and rear right wheel 23. Vehicle bed 16 is shown in profile with bed side walls 26. Module interface 34 is shown positioned adjacent to (and in most applications, connected with) module frame 36. Also shown in FIG. 2, in association with vehicle cab 14, are windshield 70 and cab roof panels 72. In a preferred embodiment, roof panels 72 may be removable and/or comprise safety glass components for improved operator visibility.

The power train of vehicle 10 is shown generally in dashed outline form in FIG. 2 as it would be positioned beneath the frame and body of the vehicle. In this view, vehicle engine 50 is shown in conjunction with vehicle engine compartment 12. Extending rearward from engine 50 is vehicle transmission 52. Extending further from vehicle transmission 52 is primary drive shaft 54. Drive shaft 54 is initially connected to first rear differential 56. First rear differential 56 drives first right drive axle 62 and first left drive axle 64 to power the forwardly positioned axle of the two rear drive axles of the vehicle.

Extending from first rear differential 56 in the manner of a power takeoff (PTO) drive shaft, is secondary drive shaft 58. This secondary drive shaft 58 drives second rear differential 60 which in turn drives second right drive axle 66 and second left drive axle 68. These latter drive axles power the rear most drive axle of the vehicle, and operate in conjunction with the first rear differential and its associated drive axles.

In addition to the primary drive train described above, the vehicle of the present invention incorporates a power takeoff (PTO) 53 positioned in association with transmission 52. Power takeoff 53 incorporates its own takeoff drive shaft 55 which is directed up into module interface 34 where it terminates as power takeoff drive coupling 57. This coupling is designed to connect with a coordinating drive shaft associated with any of a number of different removable modules of the present invention. As described in more detail below, many of the removable modules require motorized rotational power to operate the systems they incorporate. In some instances this motorized power can be supplied by a motor contained within the removable module. In the preferred embodiment it may often be easier to make a connection between the removable module and the power takeoff drive shaft components by way of power takeoff drive coupling 57 to reduce the equipment required within the removable module itself.

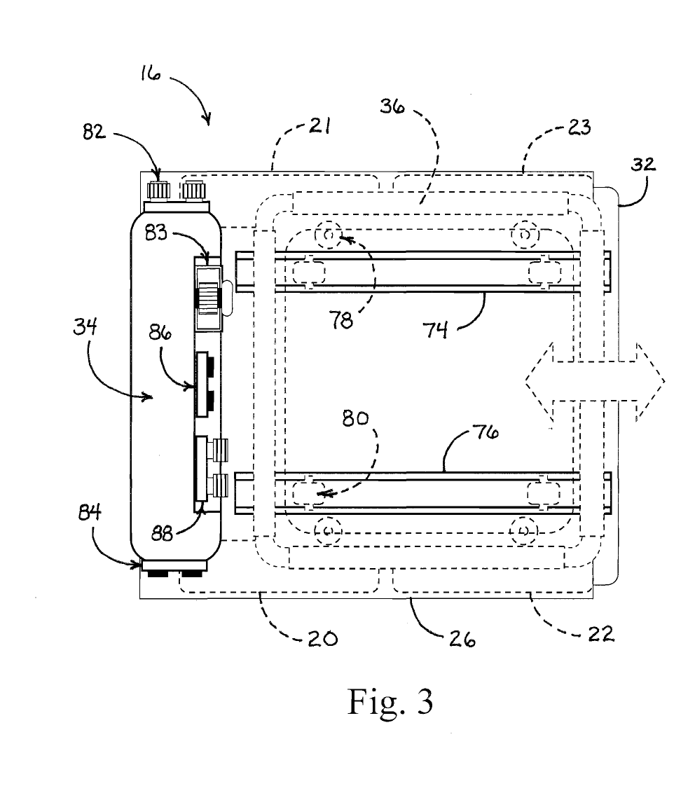

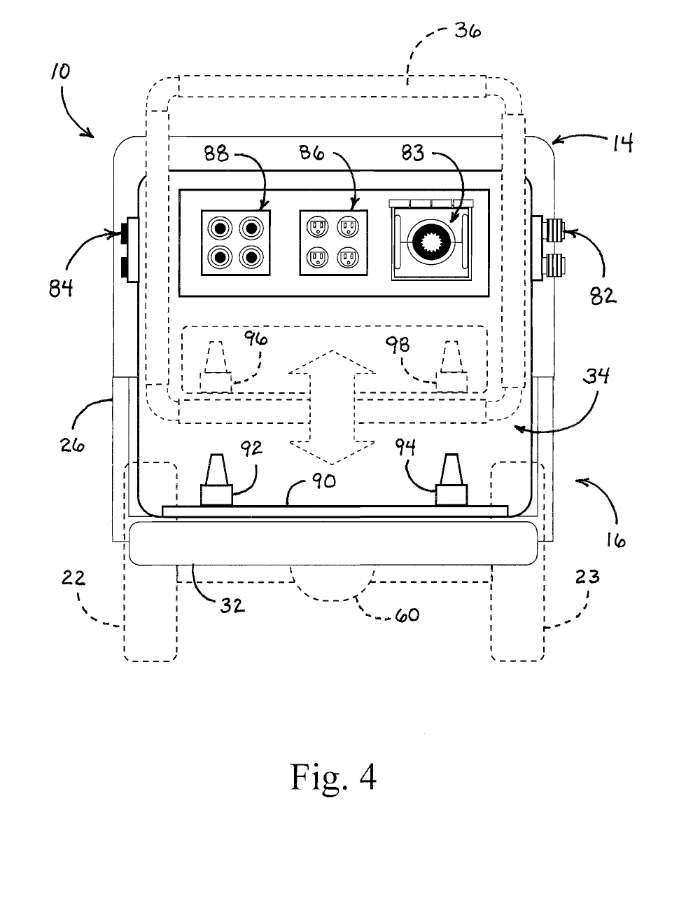

Reference is now made to FIGS. 3 and 4 for a detailed description of two alternate methods by which the removable modules of the present invention may be positioned and retained within vehicle bed 16. FIG. 3 discloses in a top plan view detail, a first sliding rail method for connecting the removable modules of the present invention into the vehicle bed 16. In this view, vehicle bed 16 is shown with bed side walls 26 and a rear end opening (with or without tailgate) into the enclosed bed positioned above bumper 32. On the floor of vehicle bed 16 are positioned two parallel rails 74 and 76 configured to receive a plurality of rollers configured on the base of the removable module. Rails 74 and 76 are preferably of channel rail configuration defining an interior channel between two side rails. Removable module frame 36 is shown in dashed line detail in FIG. 3 positioned as it would be fully within the confines of vehicle bed 16. On the base of module frame 36 are positioned four horizontal rail rollers 78 and four vertical rail rollers 80. Rollers 80 are positioned and sized to fit within the interior slot or channel of rails 74 and 76 and provide the vertical (weighted) support for the removable module. Horizontal rail rollers 78 are positioned to enclose rails 74 and 76 on their outside edges thereby maintaining the lateral placement of the removable module within the bed 16. The removable module, and more specifically module frame 36, may be lifted into place at the rear of the vehicle, whereby vertical rail rollers 80 engage the open center slots or channels associated with rails 74 and 76. The removable module may then be rolled into vehicle bed 16 with horizontal rail rollers 78 engaging the outside edges of rails 74 and 76. Once in place within vehicle bed 16, other means for securing the removable module within the vehicle may be provided. Such securing mechanisms could be any of a number of different means for preventing the lateral (primarily front to back) movement of the module out the rear of the vehicle. Examples of such stabilizing means could include fixable blocks positioned within the rails or simply the closure of vehicle bed 16 with a tailgate or the like (not shown). Other means might include set pins or tie down straps to keep the removable module fixed in its position within vehicle bed 16.

Also shown in FIG. 3 in the top plan view presented, is module interface 34. A number of interconnection devices and panels are disclosed and suggested in this view. Included are pneumatic/hydraulic quick disconnects 82 positioned in a side accessible location on module interface 34 as well as electrical/control plug connectors 84 positioned on an opposite side accessible location. Also shown in FIG. 3 is power takeoff drive shaft coupling 83 which, as described above, provides rotational power to any of a number of components that might be incorporated into the systems contained within the removable modules of the present invention. An example of such use of a power takeoff is described in more detail below.

Further shown in FIG. 3 are electrical/control plug connectors 86 which are in an in-line configuration, potentially suitable for automatic connection with connectors positioned on the removable module. In a similar manner, pneumatic/hydraulic quick disconnects 88 are configured in-line with the direction the removable module may be slid into the vehicle bed. Depending upon the type of connection and the requirements for attachment, these rearward facing connectors may automatically engage as the removable module is inserted into the vehicle on the rails as described above. It is anticipated that the connection panels shown might be variously situated on or through existing walls and floorboards of the vehicle of the preferred embodiment. Once again, the interface panel shown and described herein is intended to provide clarity for the manner in which the interconnection between the vehicle and the removable modules may be accomplished.

The interconnect structures mentioned briefly above are but examples of the manner in which the power and control systems of the vehicle of the present invention may be connected to the various removable modules of the present invention. It is anticipated that in some cases automatic connections might be provided in the manner of the in-line connectors described above. It is also anticipated however that flexible cable and hose connections incorporating quick disconnect couplings may be manually positioned and connected once the removable module is fixed in place within the vehicle bed. Various requirements for different removable modules may lend themselves to either the in-line automatic connection described or the manually connected flexible cables and hose couplings. As one objective of the present invention is versatility with respect to the reception of a variety of different removable modules, module interface 34 is, in the preferred embodiment, a versatile structure with a large number of differently configured connectors and connection panels.

Reference is now made to FIG. 4 for a detailed description of an alternate manner of connecting the removable modules of the present invention with the motor vehicle. The view in FIG. 4 is at the rear of vehicle 10 looking forward into vehicle bed 16. In this view, vehicle cab 14 is shown behind vehicle bed 16 with bed side walls 26 shown on either side. Bumper 32 is positioned at the base of vehicle bed 16. Module interface 34 is seen in this plan view as it might be positioned on the back of vehicle cab 14. Module frame 36 shown in dashed outline form in FIG. 4 in this particular manner of placement, being lowered into vehicle bed 16 from above. This vertical placement of module frame 36 is facilitated by the preferenced alignment between left rear alignment/connector post 92 and left rear module alignment/connection socket 96, as well as right rear alignment/connector post 94 and right rear module alignment/connection socket 98. Alignment posts 92 and 94 are fixed in position on drop in module platform 90 which is itself fixed into the bottom of vehicle bed 16. The view shown discloses only two of the preferred four or more mating alignment posts and sockets.

The manner of insertion and retention of the removable module shown in FIG. 4 allows for the immediate prevention of the lateral movement of the module within the vehicle bed because of the multiple (four in the preferred embodiment) placement of the alignment connector posts. As these four posts align with the four sockets configured within the base of the removable module, the specific centering of the module within the vehicle bed is accomplished. In addition, the posts and sockets may contain retention devices such as locking pins or the like that once in place may be set to fix and retain the removable module vertically within the vehicle bed. Alternately, other mechanisms for retaining the removable module within the bed may be utilized as described above in conjunction with the first, rail based manner of placement.

Also shown in FIG. 4 in the rearward facing plan view are the various connection panels associated with module interface 34. In this view, pneumatic/hydraulic quick disconnects 82 positioned on the side of module interface 34 is seen opposite electrical/control plug connectors 84. Power takeoff drive shaft coupling 83 is shown positioned where it may receive a coupled drive shaft configured on certain removable modules of the present invention. Likewise, pneumatic/hydraulic quick disconnects 88 are shown in a position where they may be automatically utilized with an in-line connection made with the removable module. Finally, electrical/control plug connectors 86 are likewise shown in a rearward facing orientation on the back panel of module interface 34.

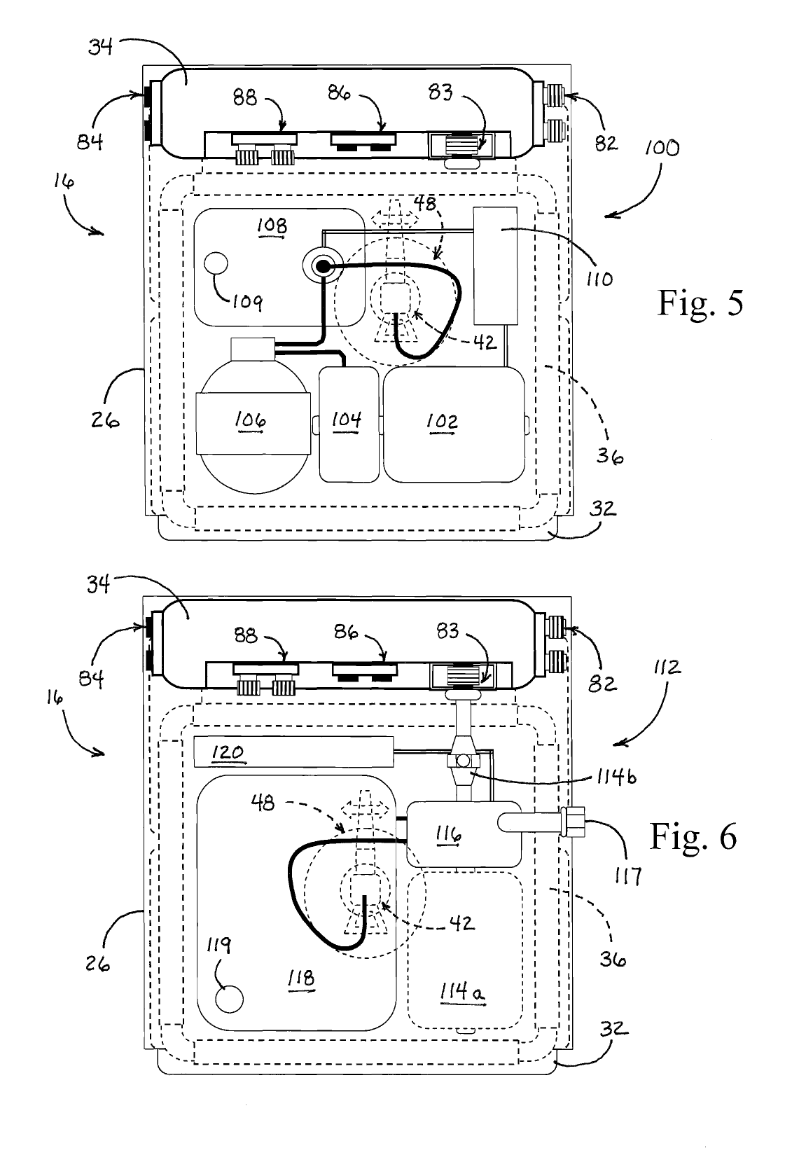

Reference in now made to FIGS. 5 and 6 for two further examples of a typical removable module of the present invention. These examples are intended to provide indications of the manner in which power and control connections may be made between the vehicle of the present invention and the removable modules. The examples provided in FIGS. 5 and 6 (and those additional modules described thereafter) are intended to suggest a wider range of possible modules that could be configured and integrated into the overall system of the present invention. Variations on the individual modules for a particular application, as well as variations that define further modules and applications are anticipated.

In FIG. 5 a compressed air foam module is generally shown in schematic form. In FIG. 5, vehicle bed 16 is again viewed from above with module interface 34 positioned opposite the tailgate section of the vehicle bed 16. Bed side walls 26 define module frame 36 in its position placed up against module interface 34. In FIG. 5, positioned within module frame 36 are the basic components of a compressed air foam system (CAFS). Such systems are typically utilized in conjunction with firefighting activities and involve a combination of compressed air with foam making chemicals, typically in liquid form. In the schematic configuration shown in FIG. 5 CAFS module 100 is primarily composed of an electric or gas operated motor 102 which is positioned to turn air compressor 104. Air compressor 104 pumps and compresses air within compressed air tank 106 where it is supplied through a regulated valve to liquid foam tank 108. The regulated valve positioned on top of liquid foam tank 108 draws the liquid up into a stream of compressed air and thereafter into appropriate delivery tubes to pressure nozzle 42, which is positioned on nozzle rotation platform 48 (shown in dashed line detail). Liquid foam tank 108 is configured with an accessible fill port 109.

Operation of the system components described is carried out by control instrumentation 110 which is preferably accessible from both outside and inside the vehicle. Control instrumentation includes operation of motor 102 as well as control over the electromechanically operated valve positioned in associated with liquid foam tank 108. In this manner, known to those skilled in the art, delivery of the compressed air foam compound onto the area surrounding the vehicle can easily be accomplished. As mentioned above, motor 102 could in an alternate embodiment be replaced with a connection to the power takeoff drive shaft coupling 83 positioned in module interface 34. An example of such an alternate power coupling is described below in association with FIG. 6.

Reference is now made to FIG. 6 for a detailed description of a high flow water pumper module configured for placement and connection with the vehicle of the present invention. In this view (the same top plan view as that shown in FIG. 5), module frame 36 encloses and positions a number of components suitable for providing a pressurized flow of water for firefighting operations. Included in a first embodiment of this pumper module 112 is an electric or gas motor 114a that connects to and drives high pressure water pump 116. Alternately, motor 114a may be avoided and substituted with power takeoff drive shaft connection 114b. Drive shaft connection 114b may be connected to power takeoff drive shaft coupling 83 in module interface 34 as described above. In this manner, pump 116 is driven either by power provided by the vehicle or by a separate electrical or gasoline powered motor positioned within the removable pumper module 112. In either case, pump 116 is configured to draw stored water from water tank 118 having fill port 119 and to direct the pressurized water through the appropriate tubing to pressure nozzle 42 positioned on nozzle rotation platform 48.

Alternately, pumper module 112 may be connected to an available external water source such as a fire hydrant, by way of water hydrant coupling 117. The operation of the system in either case is controlled through control instrumentation 120. The removable module shown in FIG. 6, although configured in the example for the pumping of water, may be configured for the pumping and spraying of any of a number of liquid fire retardant or extinguishing compounds.

Once again it is understood that both of the systems shown in FIGS. 5 and 6 may include a further alternate embodiment associated with the removable modules directed towards the pressurized dispensing of fluids obtained from external sources such as compressed air foam tanks and/or water supplies. In either case, the systems described might be connected to an outside source of the fluid, such as in the case of FIG. 6 where the water pump may be connected to an outside hydrant next to which the vehicle is positioned. This ability to pump water through the system, either from a tank held on the vehicle, or from an outside water source such as a hydrant, provides the kind of versatility normally associated only with the larger type of firefighting vehicles. Appropriate valves for re-directing the flow of water from one or the other of the water sources would be utilized in order to take advantage of available water from an outside source.

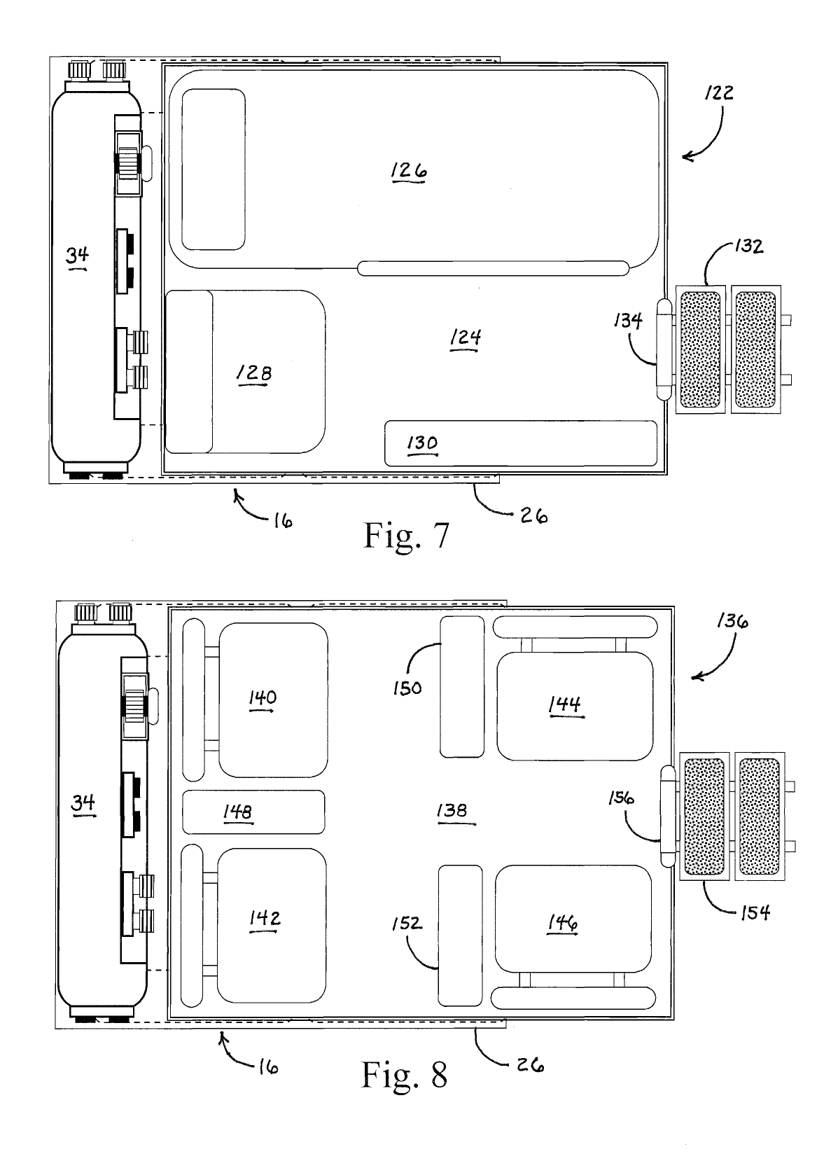

Reference is now made to FIGS. 7 and 8 to further alternate removable modules appropriate for use in conjunction with the vehicle of the present invention. The modules shown in FIGS. 7 and 8 are directed towards fire rescue and fire crew transport rather than firefighting components and systems. FIG. 7 represents an ambulance module embodiment of the present invention, while FIG. 8 represents a work crew transport module. Vehicle bed 16 shown in FIG. 7 is joined with a larger (primarily longer) module suitable for enclosing an individual that may require rescue as well as an attendant individual providing rescue services. Vehicle bed 16 is shown in this top plan view within bed side walls 26 and positioned against module interface 34. Module floor/platform 124 provides the basic floor structure for ambulance module 122. Stretcher/bed 126 is configured along one side of ambulance module 122 while attendant seat 128 is configured on the opposing side. Medical equipment storage 130 may also be provided in the remaining space associated with the enclosure defined by ambulance module 122.

Folding access steps 132 positioned on steps hinge 134 fold in and out of the ambulance enclosure to allow access and egress by both the rescued individual and the attendant. Otherwise, ambulance module 122 is a simple enclosure in the manner of a camper shell type enclosure that fits on the back of the vehicle of the present invention within the confines of vehicle bed 16. Attachment may be by either of the means described above and may be supplemented by appropriate hooks, straps, and other securing devices. Connection between the removable module and module interface 34 may take the form of simple electrical connections or may include conduit connections associated with the circulation of cooled or warmed air between the cab of the vehicle and the ambulance module enclosure. Such connection may take the form of a rigid plenum that incorporates electrical fans for directing the flow (circulation) of air into and out from the module, or may take the form of flexible hoses that pump the air between the vehicle and the module. Alternately, the module may retain its own climate control system such as with a roof based air conditioning device. As the removable modules shown in FIGS. 7 and 8 each involve carrying passengers, the preferred embodiment of each would include radio and/or intercom communication connections between the module and the vehicle cab. Alternately, or in addition, the removable modules could incorporate their own stand alone emergency radio system or other RF communication system. Further power and/or control connections between the vehicle of the present invention and the ambulance module may be anticipated.

FIG. 8 describes a work crew transport module similar in most respects to the structure and configuration of the ambulance module identified in FIG. 7. In place of the stretcher/bed found in the ambulance module, additional smaller folding jump seats 140, 142, 144, and 146 are provided. Dispersed between these jump seats are a number of cargo boxes 148, 150 and 152 suitable for holding the equipment or supplies associated with the work crew's assigned tasks. Like the ambulance module, work crew module 136 incorporates a module floor/platform 138 to the rear of which is attached folding access steps 154 mounted on steps hinge 156. Connections similar to those between the ambulance module and the vehicle of the present are anticipated between the removable work crew transport module and the vehicle. Climate control systems may either be shared or operated separately.

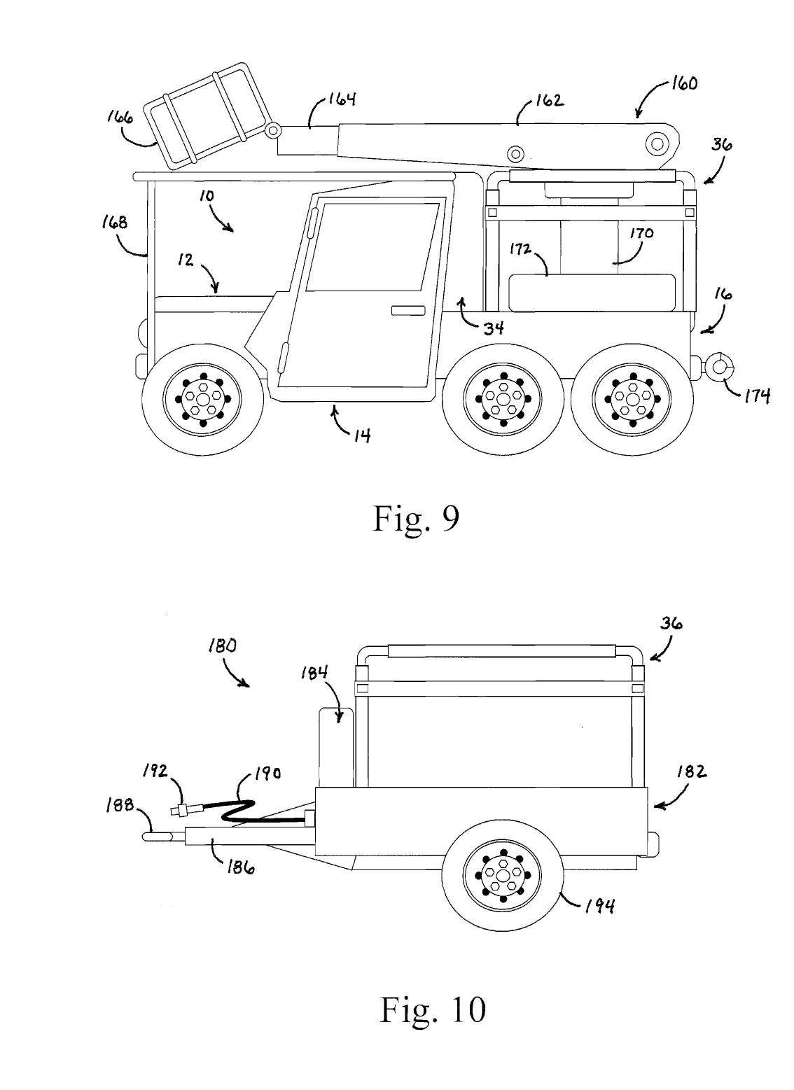

Reference is now made to FIG. 9 for a description of an example of a power boom module fitted to the vehicle of the present invention. FIG. 9 shows a side view of vehicle 10 including vehicle engine compartment 12, vehicle cab 14, and vehicle bed 16 with extension boom module 160 in place. Extension boom module 160 includes module frame 36 as described above in conjunction with other removable modules. In addition, however, this module includes hydraulic/electric lift system 162 which incorporates hydraulic/electric extension boom 164. In this example, a worker “cherry picker” bucket 166 is attached to the end of hydraulic/electric extension boom 164. Alternate embodiments structured in generally the same manner include ladder components in place of the worker bucket 166. Further alternate embodiments might provide an extensible spray nozzle or other liquid dispensing pressurized fluid system positioned at the end of the extendable boom.

Vehicle front boom support platform 168 provides the necessary support for the boom and its attachment when in a lowered configuration. Boom support/pivot 170 allows the extension boom to rotate through 360° for full access to the area surrounding the vehicle. Heavy duty boom support platform 172 is positioned in the base of extension boom module 160 and provides the necessary support to maintain the lift system in place within the vehicle while in use. Side stabilizers (not shown) as are known in the art may be provided on the sides of the vehicle for ground contact to further stabilize the vehicle when the boom is extended. Module interface 34 is shown positioned to the rear of vehicle cab 14 and may provide the necessary hydraulic, pneumatic, and/or electric power to operate the lift system incorporated in the removable module.

Reference is finally made to FIG. 10 for a brief description of a trailer accessory vehicle that may be configured to receive the removable modules of the present invention in much the same manner as the vehicle bed of the primary transport vehicle of the present invention. In FIG. 10 module frame 36 is positioned within vehicle trailer 180 and specifically within the confines of vehicle trailer bed 182. A special trailer module interface 184 provides the same array of panels and connectors to convey power and control to the removable module, just as with the primary vehicle connection described above. Module frame 36 is placed within vehicle trailer bed 182 and connects to trailer module interface 184. Trailer tow bar 186 extends forward from vehicle trailer bed 182 and presents trailer towing hitch 188 for connection to the primary vehicle. Trailer left wheel 194 is shown in this side view with a corresponding wheel (not shown) on the opposite side of the trailer in this single axle system. Trailer connector 190 is shown as an example of the flexible cable and/or tubing connector that extends from trailer module interface 184 through appropriate quick disconnects to the primary vehicle. Vehicle towing hitch 174 shown in FIG. 9 is positioned as appropriate for connection to trailer towing hitch 188. Connector quick disconnect 192 as an example, is provided to make the necessary power and control connections between the trailer and the primary vehicle.

Although the present invention has been described in terms of the foregoing preferred embodiments, this description has been provided by way of explanation only, and is not intended to be construed as a limitation of the invention. Those skilled in the art will recognize modifications of the present invention that might accommodate specific firefighting and fire rescue environments and requirements. Those skilled in the art will further recognize additional means for constructing suitable removable modules to accommodate various commonly used firefighting and fire rescue systems and tools. Such modifications, as to structure, orientation, geometry, and even composition and construction techniques, where such modifications are coincidental to the type of firefighting and fire rescue environment present, do not necessarily depart from the spirit and scope of the invention.

I claim:

1. A motor vehicle for transportation on-road and off-road in conjunction with firefighting and fire rescue operations, the vehicle comprising:
(a) a removable component module, the component module configured with elements for firefighting and fire rescue operations;
(b) an open bed configured on the rear of the vehicle, the open bed comprising:
(i) a support platform;
(ii) a plurality of receiver retention devices for guiding, receiving, and retaining the removable component module into the open bed; and
(c) a dual rear drive axel assembly positioned under the open bed configured on the rear of the vehicle, the drive axel assembly comprising:
(i) first and second differentials;
(ii) a first pair of drive axels extending from the first differential;
(iii) a second pair of drive axels extending from the second differential; and
(iv) a secondary drive shaft connecting the first differential to the second differential.
